(19) United States
(12) Patent Application Publication
(10) Pub. No.: US 2009/0037871 A1
(43) Pub. Date: Feb. 5, 2009

(54) COMMUNITY-CENTRIC MANAGEMENT OF COMPOSITE APPLICATIONS

(75) Inventors: Michael Blum, Aidlingen (DE); Dieter Buehler, Tuebingen (DE); Izidor Jager, Jettingen (DE); Michael Marks, Kirchheim-Teck (DE)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/177,651

(22) Filed: Jul. 22, 2008

(30) Foreign Application Priority Data
Aug. 2, 2007 (EP) 07113669.1

(51) Int. Cl. G06F 9/44

(52) U.S. Cl. 717/101

(57) ABSTRACT

The present invention relates to the field of portal programming and in particular to a method and respective system for managing community control information in a portal environment. In order provide a method and system which facilitates the management of community membership information required for portal composite applications, it is proposed to generate and store a “user-to-role mapping” data item (55) in a respective storage structure and use that as re-usable control information intended to be easily re-usable for further or even many composite applications, which are managed including the use of that storage structure.

### CROSS-REFERENCE TO RELATED APPLICATIONS

This application claims priority under 35 U.S.C. §119(a) to European Patent Application Serial Number EP07113669.1, filed 2 Aug. 2007, entitled “Community-Centric Management of Composite Applications,” the entirety of which is incorporated herein by reference.

### 1. BACKGROUND OF THE INVENTION

1.1. Field of the Invention

The present invention relates to the field of portal programming and in particular to a method and respective system for managing community control information in a portal environment.

1.2. Description and Disadvantages of Prior Art

In such portal environment, a plurality of composite application (CA) is usually used for providing at least a part of the portal functionality for members of one or more user communities. Herein, an administration user administrates an application-specific membership of a user to an application role.

FIG. 1 illustrates the most basic structural components of a prior art hardware and software environment used in the context of the present invention.

A portal composite application infrastructure is known from prior art, for example from IBM's WebSphere Portal. Within this portal composite application infrastructure 10 a plurality of N applications 12a . . . 12n are stored in form of respective application instances. For each of those applications 12 a respective application community 14a . . . 14n is defined. The composite applications 12 may access a database 16 storing the composite application data.

### Introduction to Portal Composite Applications:

Portal composite applications are a key concept of the Service Oriented Architecture (SOA). They allow end-users to assemble business logic out of a set of given business components without programming by simply defining meta information, such as configuration data and application structure. Composite Applications are supported by IBM's prior art WebSphere Portal and other products. In IBM's WebSphere Portal an extension called Application Infrastructure (AI) provides the support for Composite applications.

With special reference to the technical problem related to the present invention a composite application is used by a specific set of portal users called Community. To become a member of an application community a portal user has to be assigned to at least one application role by a basically application-specific membership manager. Thereafter the user has all permissions and respective access rights to business data as specified by its application role. Typical roles are supervisor, manager, editor, user. But generally, those roles are domain-specific and thus individual for any business.

The application infrastructure provides programmed functions which enable to create portal application instances based on predefined templates. A template defines business components and application roles which specify permissions for the included components and parameters which are resolved during the creation of an application instance.

The usage of such parameters allows the configuration of the appearance and the behaviour of the created applications. Thus, one template can be used to create multiple flavours of one single application type. Template parameters are also called “Points of Variability” (POV). At the time when a composite application is created, all Points of Variability (POV) defined in the application template have to be set, i.e., filled with useful variable values.

An example of such a POV is a configuration setting that is used to address the mail server which should be used to send and receive notes from inside the application components. In this scenario the application template will define a parameter for this configuration setting, and the value provided at the creation time will have to be set with the mail server address that shall get used by the application mail component during the application runtime.

To become a member of an application community a portal user has to be assigned to at least one application role by an application specific membership manager. Thereafter, the user has all permissions specified by this application role. With respect to the above mentioned multiple business components a template is comprised of, and with respect to the plurality of users which are usually equipped with specific rights associated with such business components, it is quite complicated to manage the overall access rights for those composite applications.

It should be further noted that a given template instance is typically instantiated multiple times in the system resulting in multiple application instances of that template. Such application instance is then stored on the hard disk of the system and is run such as usual programs are run. Those application instances contain distinct application role instances as defined within the template. The membership information for such application role can be managed individually within each application. A portal user can be in the same application role in many of those composite applications originating for the same template. If specific user actually need to be in many of those roles, the corresponding role assignments have to be individually created in prior art within each application instance. Thereby the membership manager has to repeat the same role mapping over and over again. This is a manual task which may lead to configuration errors resulting in undesired, unintended or insufficient role assignments.

Further problems may arise in prior art, when there are templates that share a similar application role layout and a given corporate security policy demands specific users to always be assigned specific application roles. For example, a policy may require that a predefined set of users always has to be assigned the “supervisor” role in all application instances. Disadvantageously, in prior art the membership information telling which user plays which role in which composite application must be managed manually and individually for each composite application. This is a time consuming and error prone task which increases maintenance cost and the risk for creating security exposures due to inconsistent membership management.

FIG. 2 illustrates the control flow of the most important steps of a prior art method performed to manage the adding of a user having the role of a “Manager” to a composite application, here referred to as “Teamroom”.

Within this control flow the task 200 of adding a user to (n-1) specific team room composite applications as an administrator, i.e. having the administrator role, shall be performed. In order to do that, in a first step 210 the management team determines the team room manager for team room composite application 1 and sends information to the manager about the planned action in step 220. Then, in a next step 230 the team room manager adds the user to the application community of composite application 1 as “administrator”. This is, the role of this user is defined to be “administrator”. Then, in a further step 240 the team room manager confirms this action to the management team and finally in a step 250 the management team checks the modification, if it was successful or not, in particular for this composite application team room 1. In case of success this sequence of steps is finished in a separate step 270. Otherwise it is branched back to step 220, in order to repeat this procedure.

Disadvantageously, the same procedure must be run through for each of the composite applications 12a . . . 12n depicted in FIG. 1, in order to define for each one of them a “manager” role and a respective user behind that role. So, as a person skilled in the art may appreciate, this work is dominated by manual work and is thus error prone.

1.3. Objectives of the Invention

The objective of the present invention is to provide a method for managing community control information in a portal environment which facilitates the management of community membership information required for portal composite applications.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

The key idea of the present invention comprises to generate and store a “user-to-role mapping” data item in a respective storage structure and use that as re-usable control information intended to be easily re-usable for further or even many composite applications, which are managed including the use of that storage structure.

This reduces the efforts required for administrating the composite application hosted on the portal. Thus, the community mapping information, i.e. which user belongs to which community, and the application role mapping information, i.e. which user has which application role in which composite application or even in which business element of a composite application is made reusable by the inventional method. This can be achieved by different implementations, of which the most preferred ones are summarized as follows:

First, sharing a single community between several application instances. By this, one can administrate the community information by a single administrator for all referencing applications outside the application context. This method introduces the notion of “community”.

Second, a community profile can be provided that establishes a reusable set of user-to-role mappings stored separately from any application information. An application manager can apply a community profile to a specific application instance in order to automatically populate the application roles defined within the application.

Further, with reference to the wording of the claims, a method for managing community control information in a portal environment is disclosed, in which a plurality of composite applications (CA) are used for providing at least a part of the portal functionality for members of one or more user communities, wherein an administration user administrates an application-specific membership of a user to a community and to an application role, wherein the method is characterized by the steps of:
a) storing a user-to-application role mapping preferably in a community profile ready for being accessed by said administration user,
b) providing a user interface to said administration user in order to receive input for re-using said mapping for managing a new composite application or for changing the existing community control information of an existing composite application.

Further, advantageously, a single or a set of user-to-role mappings valid for a composite application is copied at the instantiation time of the composite application. The profile is then copied to an application instance at instantiation time.

Further preferably, the set or sets of user-to-application role mappings are stored with a respective community profile ID, and the at least one composite application references the ID in order to read community control information.

Further, a community profile can be advantageously shared between different composite applications at the runtime of a composite application.

With great advantage, more than a single community profile is stored in order to reflect complex community structures.

Further, a reference to the community profile is stored at a template associated with said composite application. This automatically incorporates changes of the community into a respective application instance and saves multiple copy procedures as compared to the copy-alternative mentioned above.

### 3. BRIEF DESCRIPTION OF THE DRAWINGS

The present invention is illustrated by way of example and is not limited by the shape of the figures of the drawings in which:

FIG. 1 illustrates the most basic structural components of a prior art hardware and software environment used for a prior art method,

FIG. 2 illustrates the control flow of the most important steps of a prior art method performed to manage the adding of a user having the role of a “Manager” to a composite application, here referred to as “Teamroom”,

FIG. 3 illustrates the most basic structural components of a inventional hardware and software environment used for a preferred embodiment of the inventional method,

FIG. 4 illustrates the control flow of the most important steps of a preferred embodiment of the inventional method set in contrast to that one of FIG. 2,

FIGS. 5 to 10 show sample scenarios when generating and using community profiles according to the inventional method.

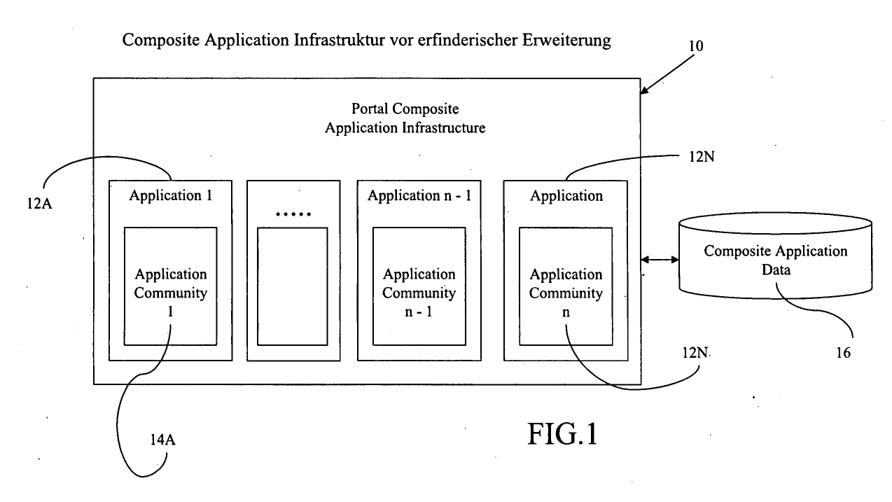

### 4. DETAILED DESCRIPTION OF THE PREFERRED EMBODIMENT

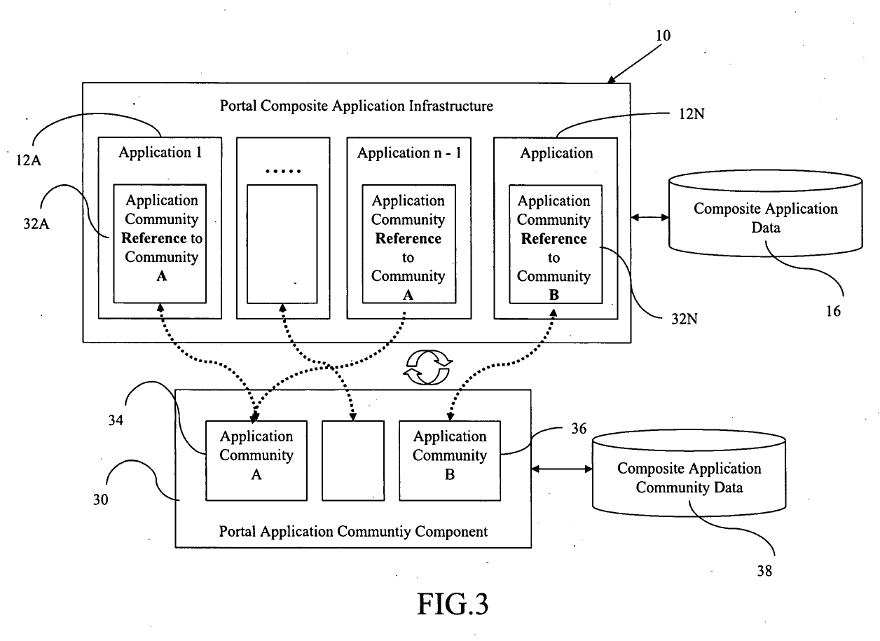

With general reference to the figures and with special reference now to FIG. 3 the structural components of an inventional hardware and software environment used for a preferred embodiment of the inventional method are embedded in a prior art portal architecture, such as IBM's WebSphere Portal.

A new, inventional component 30, the portal application community component is provided within the prior art portal infrastructure. It comprises one or more components 34, 36 which are referred to as “application community A” and “application community B”. Of course, further such community components can be stored within component 30.

An application community component 34, 36 contains all information pieces to determine which action a member of a specific composite application is allowed to do. To be able to do this a community component contains references to user information. This information may be stored in an external component, but has to uniquely identify the user, e.g. with a unique ID or name.

Additionally, a community component 34, 36 contains definitions of application roles. An application role defines specific actions that are allowed in the referencing application. Each user is then mapped to one or more specific application roles. The membership in the described application roles defines which actions the mapped user is allowed to do in the referencing application.

In contrast to prior art, each composite application 12a . . . 12n includes a reference to the respective community stored in block 30. Thus, once an application community 34, 36 is modified, for example because a staff member leaves the enterprise and must be replaced by another staff member, the reference guarantees, that each of the composite application 12 directly profits from such modification of community. Due to the fact, that the inventional portal application community component manages the different application communities 34, 36 independently of each of the composite applications 12 the maintenance of the composite applications is significantly improved because the work is to a high degree automatically done, just by using the reference to the new community data item 34, 36 respectively. Thus, in the component 30 all community membership information can be managed, such as all information can be newly generated, stored, modified and loaded and reloaded into the composite application community database 3 8 which is used as a permanent and systematic data store in this purpose.

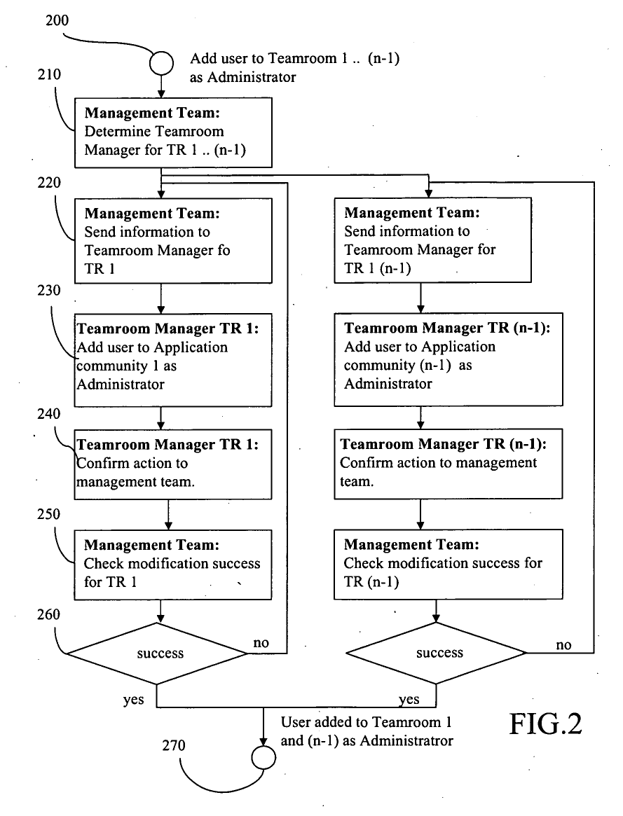

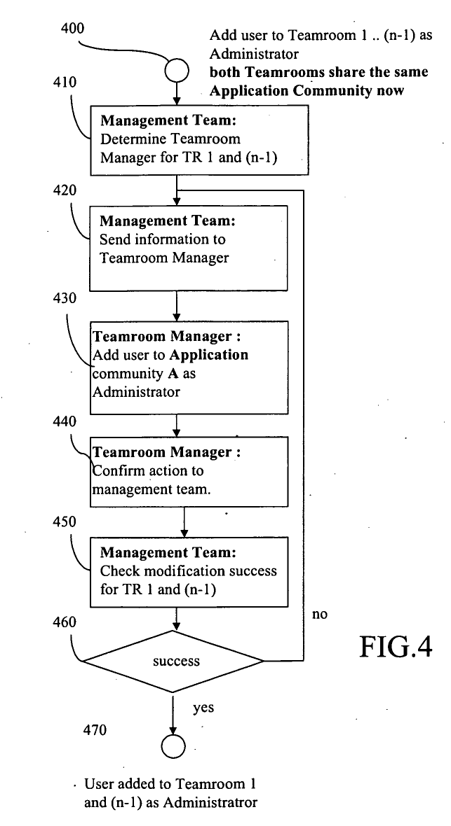

FIG. 4 illustrates the control flow of the most important steps of a preferred embodiment of the inventional method set in contrast to that one of FIG. 2.

According to FIG. 4, a sequence of steps 400 to 470 is run, when a user is to be added as a new administrator of the exemplary composite application “team room 1 . . . team room N”.

In more detail, in a step 410, the management team again determines the team room manager for all composite applications in question. Then, in a next step 420 this information is send to the team room manager himself, who performs the adding steps in order to add himself as a administrator to the respective application community A, which is intended to reflect this scope of administrating access rights to data used by the above mentioned composite applications.

Then, in a further step 440 the team room manager confirms his action to the management team which itself checks again the success of the modification for all of the composite applications in a step 450. Again, a decision 460 is run through which decides if the check step was successful or not. In the YES-branch the procedure ends up in a finalizing step 470, whereas in the NO-case it is branched back to step 420 in order to reenter the loop body.

The creation of a Community Profile—also abbreviated as “CP” can be done in different ways:

Basically, there are three possible ways to accomplish this task:
1. Exporting application roles and respectively assigned members from an existing application,
2. Manually defining new application roles outside of an application and map the members to these roles,
3. Building a new profile using an existing profile and adapting it to the needs of the new Community Profile.

All of above mentioned variants can be performed according to prior art information processing, by defining or updating respective data items and associating persons and application roles to respective business elements, and/or to different composite applications.

This information is preferably stored in a specific format and collected in a Community Profile library.

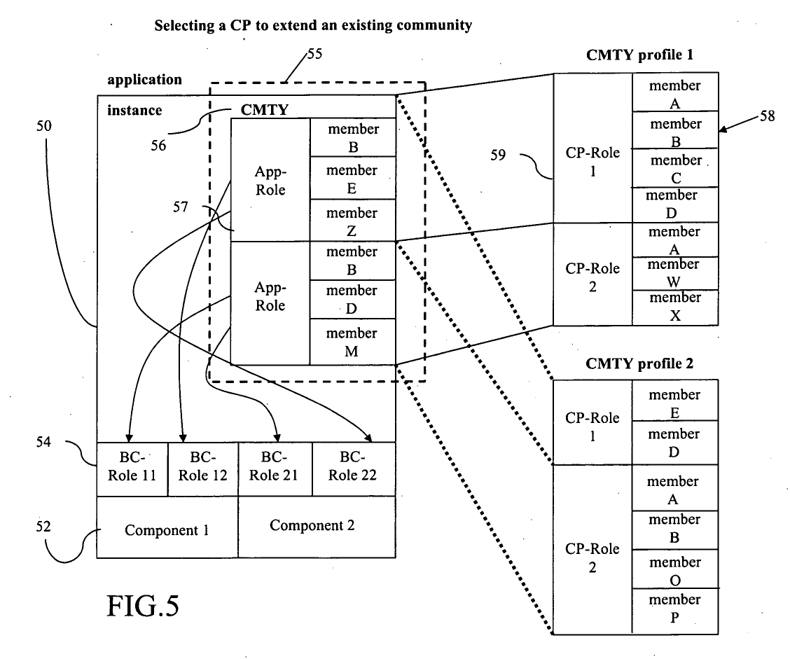

Next, the inventional usage of a Community Profile will be illustrated with reference to FIGS. 5 to 10:

Community Profiles can be used in two ways:

First and with reference to FIG. 5, by extending communities 56 of existing applications 50 (left side of FIG. 5) and thereby assigning several new application members (B,E,Z,D,M) with predefined roles 54 to these applications. An existing application community 56 can be extended by using predefined community profiles 58.

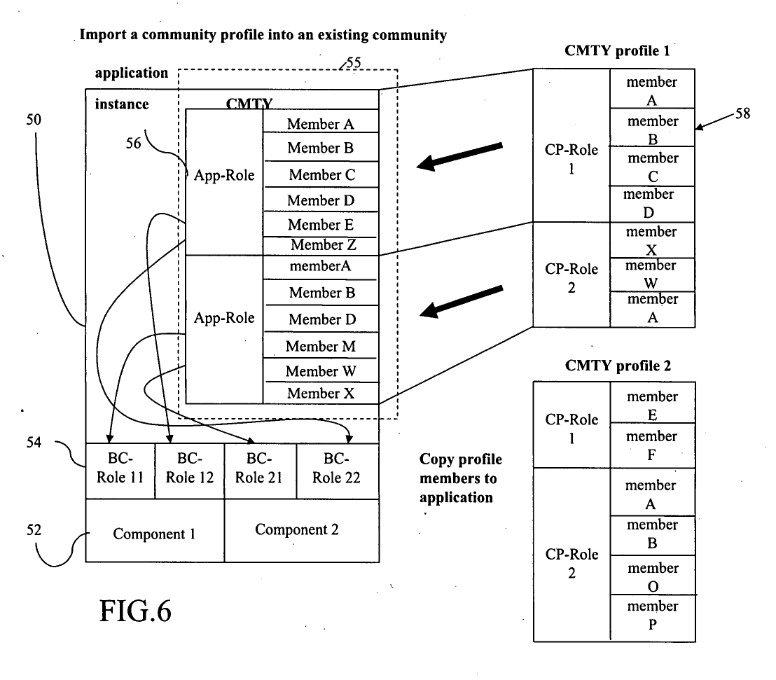

The application administrator can select a specific, predefined community profile 58. Thereafter each defined community profile role 59 has to be mapped to an existing application role 57. The members defined in each community profile role 59 will then automatically be added according to the invention to the mapped application role, see FIG. 6, yielding a user-to-application role mapping 55.

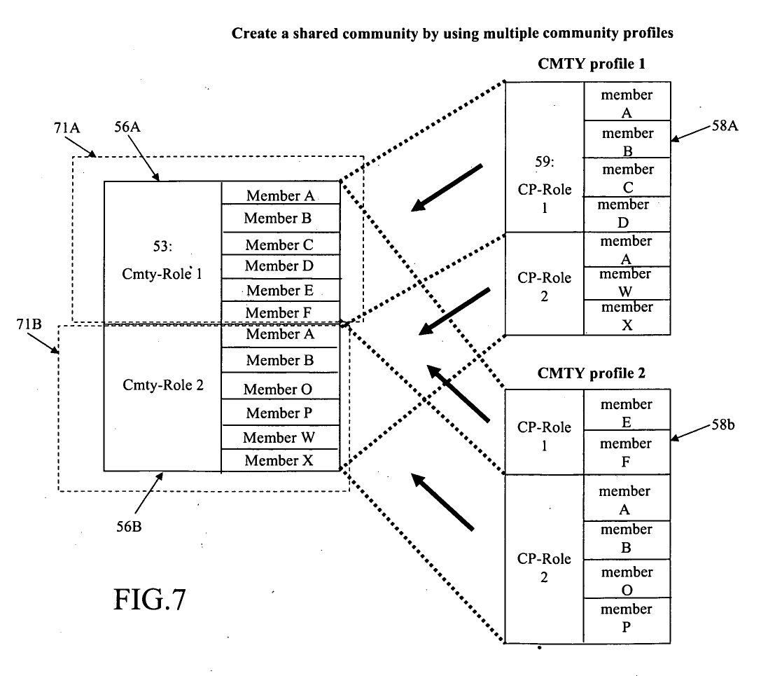

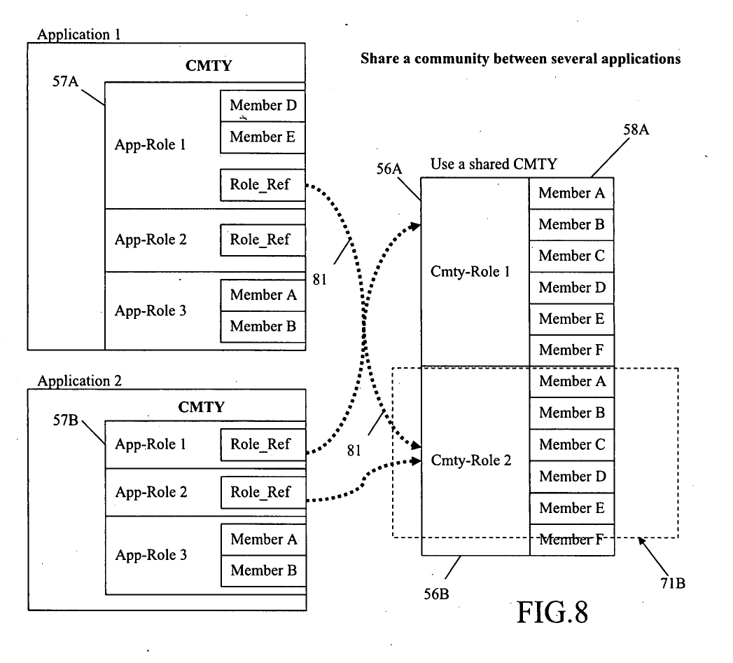

Second and with reference to FIG. 7 and 8, communities can be shared for use by multiple applications:

A community profile 58A, 58B can also be used to create a community 71 which is not a part of a composite application but exists independently from any application. The community is managed outside the application scope. Such a community can be created based on multiple community profiles 58A, 58B. A role 53 of this shared community, depicted as “Cmty-Role” can be mapped to several community profile roles 56A, 56B. All members in these profile roles are copied to the roles of the shared community 71A, 71B (FIG. 7).

A shared community 71A, 71B can be used from within multiple applications see FIG. 8:

In this case an application role 57A (e.g. App-Role1 from application 1) contains a reference (dotted arrow 81) to the used role of the shared community 71 B (Cmty-Role2). If the application has to check if a specific user belongs to a specific community role, it will check the direct members first (e.g. member D and E for App-Role1 in application 1) and will thereafter resolve the members of the shared community role. Using a shared community 71 for several applications allows an administrator to advantageously manage the application membership for all connected applications in a central place which saves time and minimizes errors.

Next, application membership management will be described:

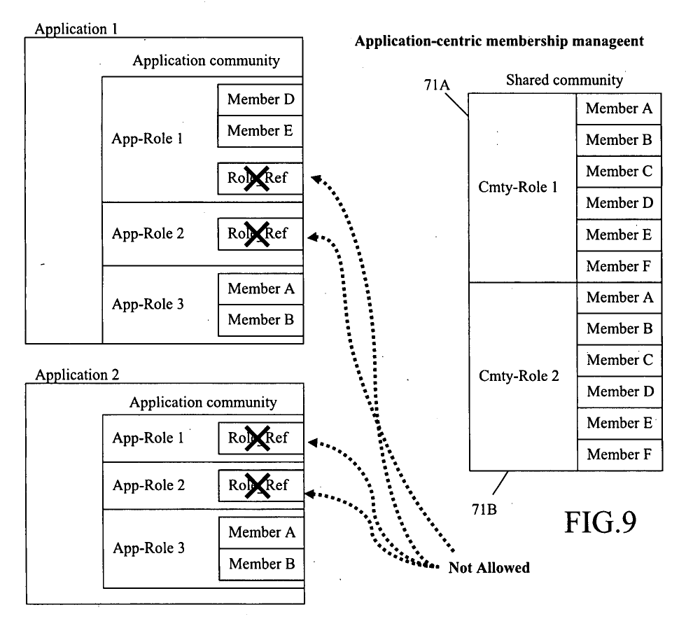

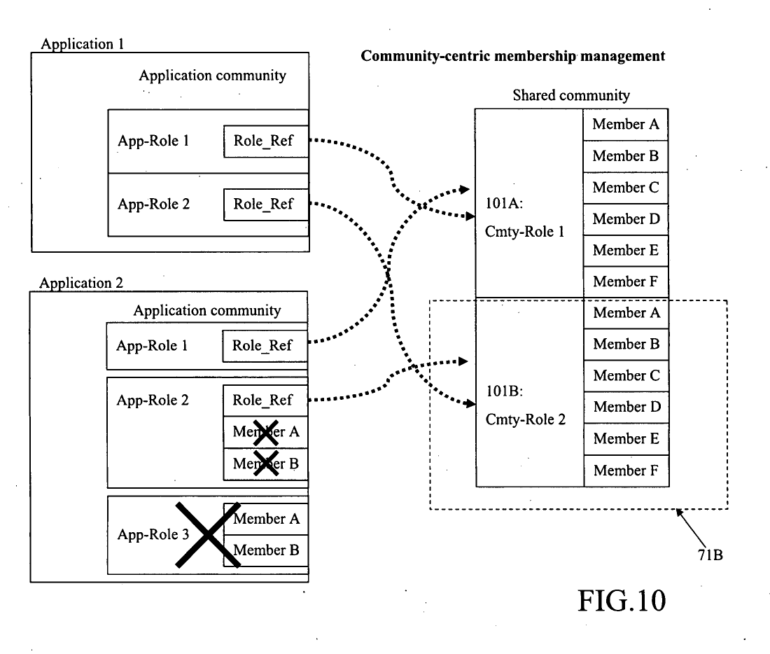

With the configuration shown in FIGS. 9 and 10 an application administrator can use two possible perspectives to manage an application membership:

With reference to FIG. 9 an “application-centric” perspective is described:

Application members are added, reassigned and removed to and from application roles within one single application. A role assignment, re-assignment or removal is valid only within this specific application and has no further side effects to other applications and their role assignments.

With reference to FIG. 10 a “community-centric” perspective is described:

Application members are added, reassigned and removed to and from roles 101A, 101B of a shared community. A role assignment, re-assignment or removal is valid for all applications which use this shared community.

Next, the aspect of restricting the usage to a specific kind of membership management will be discussed:

An application administrator may want to restrict the kind of membership to one of the two perspectives to avoid administration side effects and to be able to manage the application membership in the correct scope (one application, multiple applications).

To restrict the membership management to an application-centric perspective, the application community roles must not have references to roles of a shared community (see FIG. 9). Thus the membership management is scoped to this single application.

To restrict the membership management to a community-centric perspective each single role has to be mapped to a role of a shared community and member in application roles are only allowed through the referenced roles. There are no direct members of application roles (see FIG. 10).

Next, and with reference back to FIG. 3, and with respect to the data structure provided within the composite application community database 38, several different storage structures can be implemented.

A preferred implementation is based on database tables storing all relevant information of the shared communities 34, 36 consistently and permanently, as follows:

There are four tables, a table “profile”, a table “role”, a table “member” and a table “link profile role—member”.

The profile table stores the community profile. Each row in this table corresponds to a specific profile.

The role table describes the different roles of the different community profiles.

The member table describes the different members which are comprised of the role of the community profiles.

The link profile role member table describes the relationships between the profiles, the roles and the members. In a more summarized form the table definitions are given further below, wherein the following annotations are given:

A table has columns 1 to N.

PK is a primary key, (column 1, column 2 . . . ), such that the column 1 and column 2 serve to uniquely identify each entry in a database table, thus representing a primary key.

FK is a foreign key which links from a column in one table to a different column in a different table. So, the foreign key having the name column name 1 has a referential dependency to the column name 2 in table 2.

| | |
|---|---|
| PROFILE (ID, Name) | PK = (ID) |

| | |
|---|---|
| ROLE (ID, Name) | PK = (ID) |

| | |
|---|---|
| MEMBER (ID, Name, MemberType) | PK = (ID) |

(MemberType may be USER or GROUP)
LINK_PROFILE_ROLE_MEMBER (P_ID, R_ID, M_ID)
PK = (P_ID, R_ID, M_ID)
FK = P_ID → PROFILE.ID
FK = R_ID → ROLE.ID
FK = M_ID → MEMBER.ID

Preferred data structures for the inventional user-to-application role mapping 55 depicted in FIGS. 5 and 6 are as follows:

The preferred data structure is similar to the one of community profile data:

Application_Member (ID, Name, MemberType)
PK = (ID)
Application_Role (ID, Name)
PK = (ID)
LINK_Appl_Role_Member (AR_ID, M_ID)
PK = (AR_ID, M_ID)
FK = AR_ID → Application_Role.ID
FK = M_ID → Application_Member.ID
BC_Role (ID, Name, AR_ID)
PK = (ID)
FK = AR_ID → Application_Role.ID
Action (ID, Name)
PK = (ID)
LINK_BC_Role_Action (BR_ID, A_ID)
PK = (BR_ID, A_ID)
FK = BR_ID → BC_Role.ID
FK = A_ID → Action.ID

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method for managing user community control information in a portal environment, in which a plurality of composite applications (CA) (12A . . . 12N) are used for providing at least a part of the portal functionality for members of one or more user communities, wherein an administration user administrates an application-specific membership of a user in a user community and in an application role, the method being characterized by the steps of:
a) storing a data structure representing a user-to-application role mapping (55) ready for being accessed by said administration user,
b) providing a user interface to said administration user in order to receive input for re-using said mapping (55) for managing a new composite application or for changing an existing community control information of an existing composite application.

2. The method according to claim 1, wherein a set of user-to-role mappings (55) valid for a composite application is copied at the instantiation time of said composite application.

3. The method according to claim 1, wherein said sets of user-to-application role mappings (55) are stored with a respective community profile ID, and wherein said at least one composite application (12) references said ID in order to read community control information.

4. The method according to claim 1 wherein a community profile is shared between different composite applications at the runtime of a composite application.

5. The method according to claim 1, wherein more than a single community profile is stored.

6. The method according to claim 1, wherein a reference to said community profile is stored at a template associated with said composite application.

7. An electronic data processing system for managing user community control information in a portal environment, in which a plurality of composite applications (CA) (12A . . . 12N) are used for providing at least a part of the portal functionality for members of one or more user communities, wherein an administration user administrates an application-specific membership of a user in a user community and in an application role, said system comprising
a) storage with a stored data structure representing a user-to-application role mapping (55) ready for being accessed by said administration user,
b) and an functional component implementing a user interface to said administration user in order to receive input for re-using said mapping (55) for managing a new composite application or for changing an existing community control information of an existing composite application.

8. A computer program product for managing user community control information in a portal environment, in which a plurality of composite applications (CA) (12A . . . 12N) are used for providing at least a part of the portal functionality for members of one or more user communities, wherein an administration user administrates an application-specific membership of a user in a user community and in an application role, wherein said product comprises a computer useable medium including a computer readable program, wherein the computer readable program includes a functional component that when executed on a computer causes the computer to perform the steps of:
a) storing a data structure representing a user-to-application role mapping (55) ready for being accessed by said administration user,
b) providing a user interface to said administration user in order to receive input for re-using said mapping (55) for managing a new composite application or for changing an existing community control information of an existing composite application.
